(19) United States
(12) Patent Application Publication
(10) Pub. No.: US 2020/0274937 A1
(43) Pub. Date: Aug. 27, 2020

(54) LIVEFEED INFORMATION DELIVERY SYSTEM AND METHOD OF USE

(71) Applicants: Vera Saunchanka, Concord, CA (US); Dzianis Bindarau, Concord, CA (US)

(72) Inventors: Vera Saunchanka, Concord, CA (US); Dzianis Bindarau, Concord, CA (US)

(21) Appl. No.: 16/803,936

(22) Filed: Feb. 27, 2020

Related U.S. Application Data
(60) Provisional application No. 62/810,955, filed on Feb. 27, 2019.

(51) Int. Cl. H04L 29/08

(52) U.S. Cl. CPC H04L 67/18; H04L 67/22; H04L 67/306; H04L 67/26

(57) ABSTRACT

A LIVEfeed news and information delivery system is a world wide web platform and mobile/desktop app (collectively defined as “platform”) that revolutionizes the process of delivering news and any other informational updates, built on submissions by users, based on their geolocation. Submissions appear both in the LIVEfeed on the platform as well as in the mobile/desktop app. Submissions may go through review and moderation, and the most newsworthy ones may be picked up for further development.

Submissions are published based on specific geolocations, provided by users submitting them. When entering the LIVEfeed platform or mobile/desktop app, users see posts based on their geolocation. Users may be able to adjust the content and variety of posts based on their interests and preferences. Users may be also able to create their profile pages based on the content they're interested in, or the content they're posting.

Media and other parties worldwide may have the opportunity to buy/order content from users on the LIVEfeed platform, or post specific assignments for users to contribute. Users have to be verified and abide by the platform's terms and conditions/community guidelines.

### BACKGROUND

### 1. Field of the Invention

The present invention relates generally to information distribution systems, and more specifically, to a web or mobile platform that delivers news and other information updates to people or other users based on their geolocation. Media or other parties have the ability to purchase content from the users on the platform or make assignments thereto.

### 2. Description of Related Art

Information distribution systems are well known in the art and are effective means to transfer data from one party to another. While information distribution systems are common for all types of data, the present application focuses on the exchange of news and information that comes directly from the public and is available on the platform immediately, allowing a higher speed of news and information delivery, applicable to the modern world. Commonly, the news is prepared by a reporter, editor or the like and presented to the public through broadcast media, the internet or other forms of print media.

One of the problems commonly associated with common information distribution systems is its limited efficiency. For example, news found on the internet and cable networks address the whole of the world or the nation. While this conveys information of importance to a wide area the local areas are neglected. This also eliminates the input of the audience in the content of the news they are presented. This lack of input allows noteworthy events and stories to go unnoticed.

Additionally, as people move from one place to another it is difficult to find local news. This results in lost opportunities from lack of information include events, traffic congestion, weather and the like. Often news prepared for smaller groups is created by those not directly familiar with the local area.

Accordingly, although great strides have been made in the area of information distribution systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a LIVEfeed news and information delivery system in accordance with a preferred embodiment of the present application;

FIG. 2 is a diagram of the electronic environment that enables the system of FIG. 1;

FIG. 3 is a diagram of the portal of FIG. 1; and

FIG. 4 is a flowchart of a method of obtaining and delivering content for a geolocation.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional information distribution systems. Specifically, the present invention provides means to determine a person's location and provide hyperlocal news relevant to that location. Additionally, the invention enables the collection and direction of the news based on the geolocation of the person. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

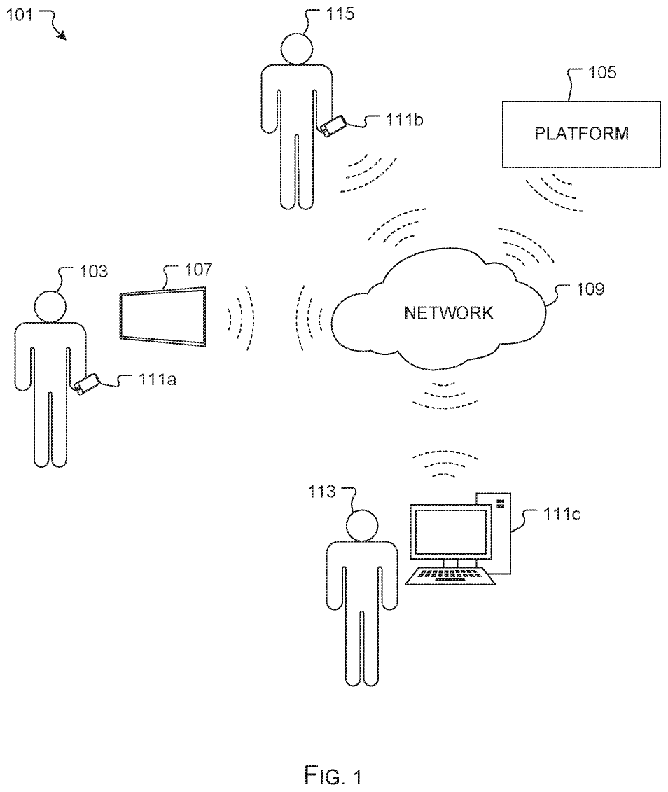

Referring now to the drawings wherein like reference characters identify corresponding or similar elements throughout the several views, FIG. 1 depicts a diagram of a LIVEfeed news and information delivery system in accordance with a preferred embodiment of the present application. It will be appreciated that system 101 overcomes one or more of the above-listed problems commonly associated with conventional information distribution systems.

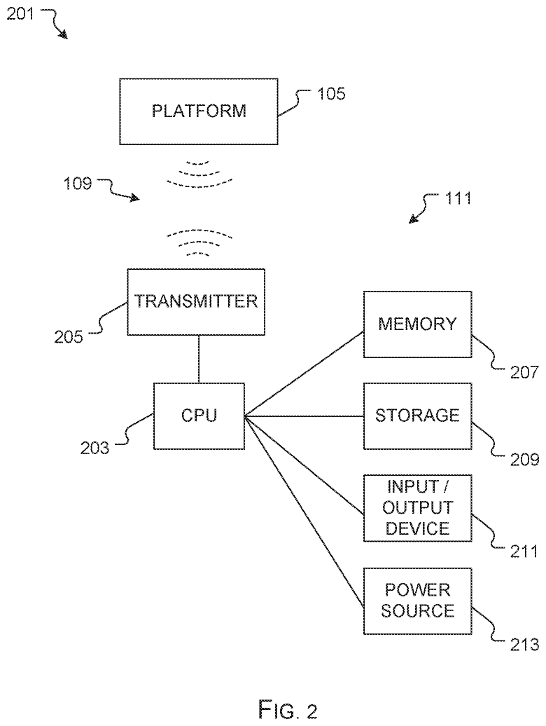

In the contemplated embodiment, system 101 includes a user 103 in electronic communication with a platform 105 via a computing device 111 and a network 109. The user 103 also includes a display device 107 that is also in electronic communication with the platform either via the computing device 111 of the user or the network 109. The system further includes a contributor 115 in electronic communication with the platform 105 via a computing device 111 and the network 109. Further, a moderator 113 in electronic communication with the platform 105 via a computing device 111 and the network 109. The electronic communication between the computing devices 111, the network 109 and the platform creates an electronic environment 201 depicted by FIG. 2.

The computing devices 111 includes components that allow for the computation and thus the activation of software. These components include a CPU 203 and a transmitter 205 that allows for communication between the computing device 111 and the network. The components further include memory 207, storage 209, input/out devices 211 and a power source 213. These components are provided as examples and it is contemplated that other components could be used. It will be understood that the computing devices allows for the exchange of data between the user 103, contributor 115 and moderator 113.

It is contemplated that in the electronic environment 201 that the moderator 113 could be assisted by digital tools or algorithms to control the content or information created by the contributors 115. It is further contemplated that the moderator 113 could be completely automated by similar tools.

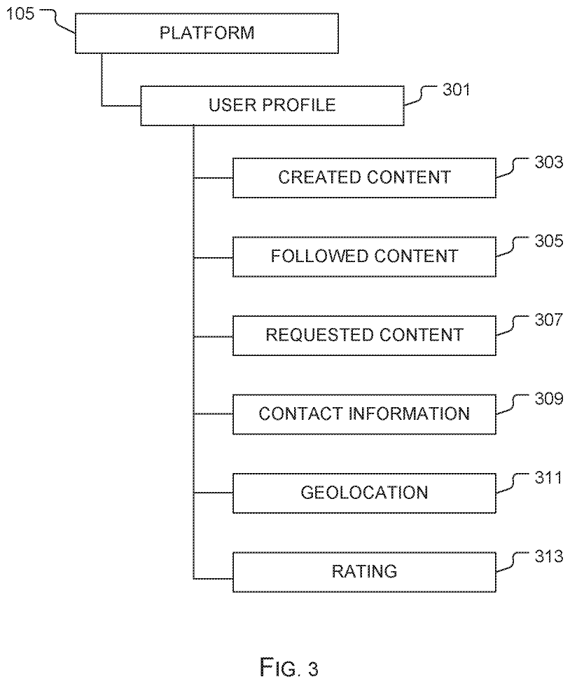

Referring now to FIG. 3 the platform is further depicted. Each user will have a profile 301 that tracks or includes created content 303, followed content 305, requested content 307, contact information 309, geolocation 311 and a rating 313. It is contemplated that both the user 103 and contributor 115 could be the same individual. The rating could be defined by the number of interactions of other users 103 on the platform 105 towards a specific created content 303, including but not limited to likes, dislikes, shares and so on and/or by an electronic algorithm.

It is contemplated that created content 303 could be purchased or that the user 103 could be otherwise compensated for created content 303. It will also be understood that the platform 105 could receive some remuneration for the service provided.

It is contemplated that the created content 303 could be classified by the moderator 113 and placed in categories for the ease of consumption by the users 103. Additionally, a stream of new content made by the contributors 115 could be formed into a LIVEfeed for a user based on their geolocation.

In use, events or occurrences are captured by a contributor 115 and are transferred to the platform 105 where they are disseminated by geolocation to users 103. The content provided by the contributor 115 is rated 313 and allows for responsibility by the contributor 115 and establishes them as a trustworthy source for other users 103. Users could request content 307 from the contributors 115. When content is received by the platform a moderator 113 could review it and either approve, modify or reject the content.

It should be appreciated that one of the unique features believed characteristic of the present application is that platform 105 enables news and other information to be created, submitted and distributed to users 103 based on geolocation 311 in a significantly shorter period of time than common information sources, often immediately.

Additionally, content or news can be requested from contributors 115 to fulfill a need for that geolocation 311.

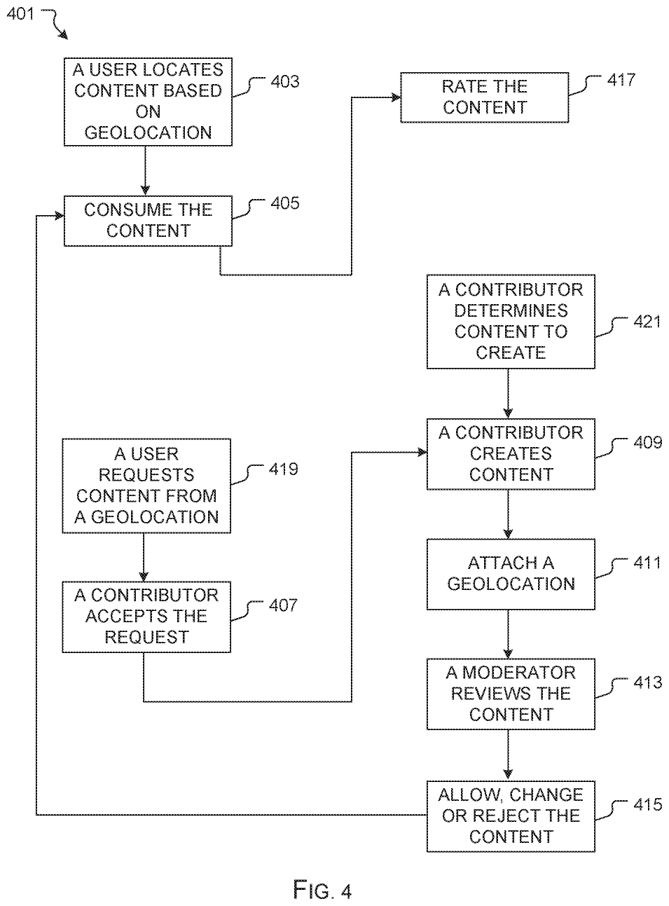

Referring now to FIG. 4 a method of delivering information within a geolocation is depicted. Method 401 includes a user locating and consuming informational content for their geolocation 403 and 405, a contributor accepting a request for informational content or determining what informational content to create and attaching a geolocation 407, 409, 411 and 421, a moderator reviewing the informational content created by the contributor 413 and allowing, changing or rejecting it 415 and a user rating the informational content 417 or the user requesting informational content from geolocation 419.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A livefeed information delivery system, comprising:
at least one computing device in electronic communication with a platform that exists in an electronic environment created between the computing devices, the platform and a network;
the computing devices including components that allow for computation;
wherein a user and contributor collaborate to create and consume news and other informational content from single geolocation.

2. The system of claim 1 wherein the user requests news or other informational content from a geolocation and wherein the contributor is in the geolocation and obtains information therefrom.

3. A method of creating and consuming informational content associated with a geolocation, comprising:
a user locating informational content for their geolocation;
a user consuming informational content for their geolocation;
a contributor accepting a request for informational content; or
a contributor determining the informational content to create;
a contributor creating informational content;
attaching a geolocation to the informational content;
a moderator reviewing the informational content created by the contributor;
a moderator allowing, changing or rejecting the news content; and
a user rating the informational content;
or the user requesting informational content from geolocation.
